(19) United States
(12) Patent Application Publication
(10) Pub. No.: US 2023/0237564 A1
(43) Pub. Date: Jul. 27, 2023

(54) ONLINE SHOPPING MALL SYSTEM USING AUTOMATED PROCESSING OF CONTENT CATEGORIES AND MAPS

(71) Applicant: Young Mi YANG, Paju-si (KR)

(72) Inventor: Hong Il PARK, Incheon (KR)

(21) Appl. No.: 18/010,814

(22) PCT Filed: May 25, 2021
(86) PCT No.: PCT/KR2021/006509

§ 371 Date: Dec. 16, 2022

(30) Foreign Application Priority Data
Jun. 26, 2020 (KR) 10-2020-0078619

(51) Int. Cl. G06Q 30/0601

(52) U.S. Cl. CPC G06Q 30/0643; G06Q 30/0635

(57) ABSTRACT

The present invention relates to an online shopping mall system using automated processing of content categories and maps. For example, disclosed is an online shopping mall system using automated processing of content categories and maps, the online shopping mall system comprising: a map database unit in which map data for at least one country is stored; a map marker generation unit in which location information, product sales information, seller information, and sales product category information for an offline store are registered, and which classifies the product sales information into categories on the basis of the sales product category information, and generates a plurality of markers for providing the product sales information and the seller information on a map provided through the map database unit on the basis of the location information; a product information provision unit which, when a specific product category is input as a search keyword, provides, on the map, product sales information and seller information corresponding to the input product category, and when a specific marker is selected from among the plurality of markers, provides, on the map, product sales information and seller information corresponding to the selected marker through a pop-up window; and a product payment processing unit which processes payment according to a product purchase request through the pop-up window.

### TECHNICAL FIELD

An embodiment of the present invention relates to an online shopping mall system through automated processing of content categories and maps.

### BACKGROUND ART

In online shopping (e-commerce), users increasingly shop using mobile terminals.

Users can do online shopping without time and place restrictions in a ubiquitous environment using the wireless Internet of a mobile terminal. Furthermore, through omni-channel shopping, users go online and offline without restrictions and purchase products after comparing prices and searching before purchasing products.

Further, with online to offline (O2O) service, users can immediately receive a product at an offline store after purchasing a product online. To provide an O2O shopping service to a mobile terminal, a service provider creates and distributes a mobile application in advance, and the mobile terminal can use the corresponding service when the application is installed.

From a service provider's point of view, there is a problem in that entry barriers to the business are high because of a limiting condition of having to build a dedicated application-based service infrastructure to provide O2O shopping services to mobile users. Further, in order to increase the number of mobile application users, there is a problem in that enormous marketing costs are incurred, such as inducing downloads of users and providing compensation therefor.

However, it is necessary to develop a system that allows users to shop more conveniently in a mobile or Internet environment by extending O2O services, which have conventionally been applied to real estate and food delivery, to shopping malls.

Prior art documents in the technical field to which the present invention belongs include Korean Patent Publication No. 10-2020-0054788 and the like.

### DISCLOSURE

### Technical Problem

An embodiment of the present invention provides an online shopping mall system through automated processing of content categories and maps that extends online to offline (O2O) services to shopping malls so that users may shop more conveniently in a mobile or Internet environment.

### Technical Solution

The online shopping mall system through automated processing of content categories and maps according to an embodiment of the present invention comprises: a map database unit storing map data for at least one country; a map marker generation unit receiving the registration of in which location information, product sales information, seller information, and sales product category information for an offline store, respectively, classifying the product sales information into categories based on the sales product category information, and generating a plurality of markers for providing the product sales information and the seller information on a map provided through the map database unit based on the location information; a product information provision unit providing, when a specific product category is input as a search keyword, product sales information and seller information corresponding to the input product category through the marker on the map, and providing, when a specific marker is selected from among the plurality of markers, product sales information and seller information corresponding to the selected marker through a pop-up window on the map; and a product payment processing unit processing payment according to a product purchase request through the pop-up window.

Further, the map marker generation unit may comprise: a sales information registration unit receiving location information including the latitude and longitude of the offline store, product sales information including product name, product picture, product video and product price, seller information including seller personal information and account payment information, and sales product category information, respectively, from the seller; and a marker generation unit automatically classifying the product sales information from a higher category to a lower category based on the sales product category information wherein the product sales information is classified so as to be searchable by the search keyword and generating the plurality of markers as an interface for outputting product sales information and seller information on a map based on the location information.

Further, the product information provision unit may comprise: a keyword-based marker extraction unit extracting, when a search keyword is input through the keyword search window, a marker of a category matching the corresponding search keyword based on the sales product category information; a marker display unit displaying at least one marker extracted through the keyword-based marker extraction unit on the map; and a pop-up window display unit displaying, when a specific marker is selected among the markers displayed through the marker display unit, product sales information and seller information corresponding to the selected marker through a pop-up window on the map.

Further, the pop-up window display unit may further display at least one of an enlarged map and a road view of a surrounding area centered on an offline store corresponding to a marker selected by a user.

Further, the system may further comprise a store image information provision unit receiving the external image of the building and the indoor stereoscopic space image information, respectively, of the offline store and providing, when a marker corresponding to each offline store is selected, the external image of the building and the indoor stereoscopic space image of the corresponding offline store.

Further, the system may further comprise a pop-up window list management unit adding, when a pop-up window displayed on the map is moved to a pop-up list area outside the map of the web page through a drag-and-drop method, the pop-up window dropped to the corresponding area in the form of a list, sorting the same by drop time, product category, and product price to display the same to be usable, and deleting the pop-up window according to a user's selection.

### Advantageous Effects

According to the present invention, it is possible to provide an online shopping mall system through automated processing of content categories and maps that allows users to shop more conveniently in a mobile or Internet environment by extending an online to offline (O2O) service to a shopping mall.

### DESCRIPTION OF DRAWINGS

FIG. 1 is a schematic view for explaining the configuration relationship of an online shopping mall system through automated processing of content categories and maps according to an embodiment of the present invention.

FIG. 2 is a block diagram for showing the overall configuration of an online shopping mall system through automated processing of content categories and maps according to an embodiment of the present invention.

FIG. 3 is a block diagram for showing the configuration of a map marker generation unit according to an embodiment of the present invention.

FIG. 4 is a view for illustrating the configuration of a main screen of an online shopping mall system through automated processing of content categories and maps according to an embodiment of the present invention.

FIG. 5 is a block diagram for showing the configuration of a product information provision unit according to an embodiment of the present invention.

FIGS. 6 and 7 are views for explaining functional configurations of a keyword-based marker extraction unit, a marker display unit, and a pop-up window display unit, respectively, according to an embodiment of the present invention.

FIGS. 8, 9, 10 and 11 are views for explaining the functional configuration of a pop-up window list management unit according to an embodiment of the present invention.

### MODE FOR INVENTION

The terms used in this specification are briefly described, and the present invention are described in detail.

The terms used in the present invention have been selected from general terms that are currently widely used as much as possible while considering the functions in the present invention, but they may vary depending on the intention or precedent of a person skilled in the art, the emergence of new technologies, and the like. Further, in a specific case, there is also a term arbitrarily selected by the applicant, and in this case, the meaning is described in detail in the description of the invention. Therefore, the term used in the present invention should be defined based on the original meaning of the term and the overall content of the present invention, not simply the name of the term.

When it is said that a certain part “includes” a certain component throughout the specification, it means that it may further include other components, not excluding other components unless otherwise stated. Further, terms such as “. . . unit” and “module” described in the specification mean a unit that processes at least one function or operation, which may be implemented as hardware or software or a combination of hardware and software.

Hereinafter, with reference to the accompanying drawings, embodiments of the present invention are described in detail so that those skilled in the art can easily carry out the present invention. However, the present invention may be embodied in many different forms and is not limited to the embodiments described herein. Further, in order to clearly explain the present invention in the drawings, parts irrelevant to the description are excluded, and similar reference numerals are attached to similar parts throughout the specification.

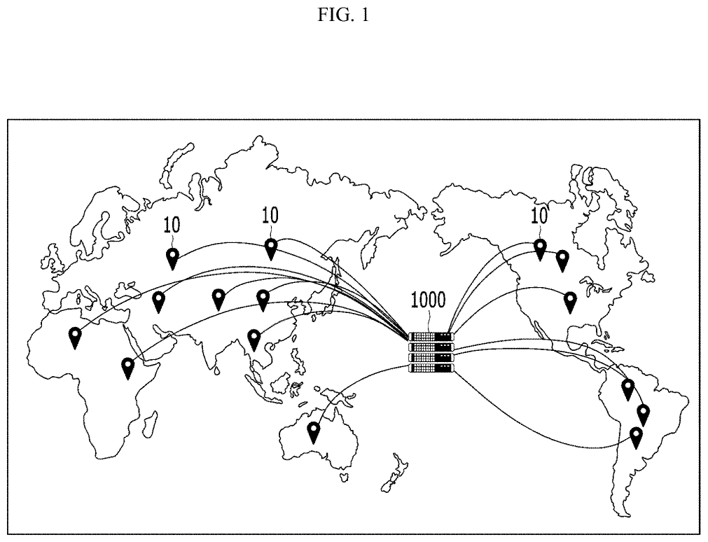

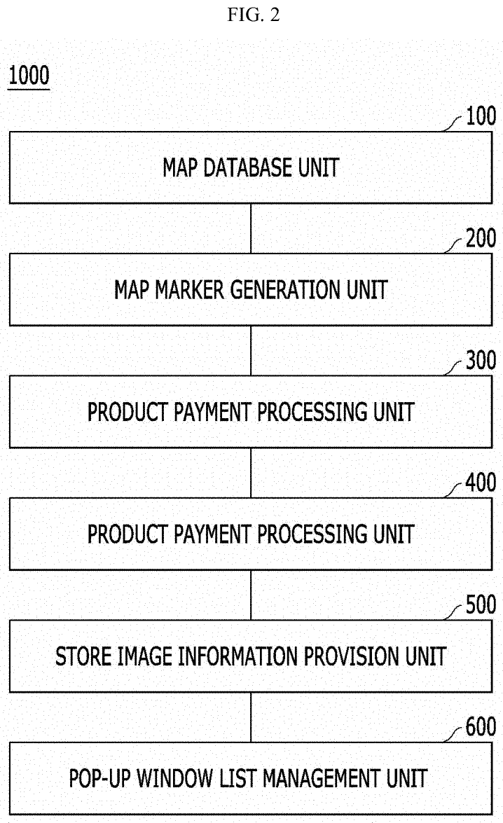

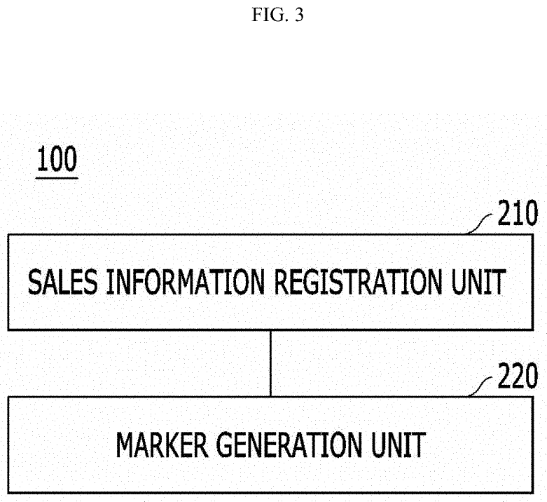

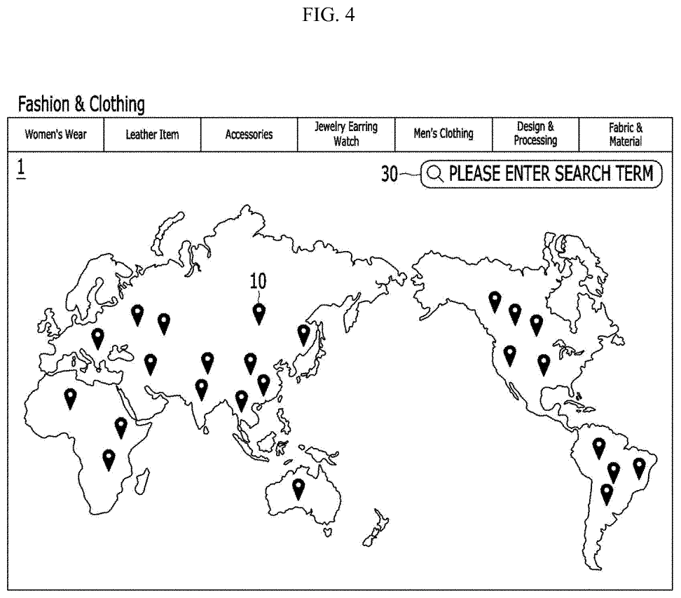

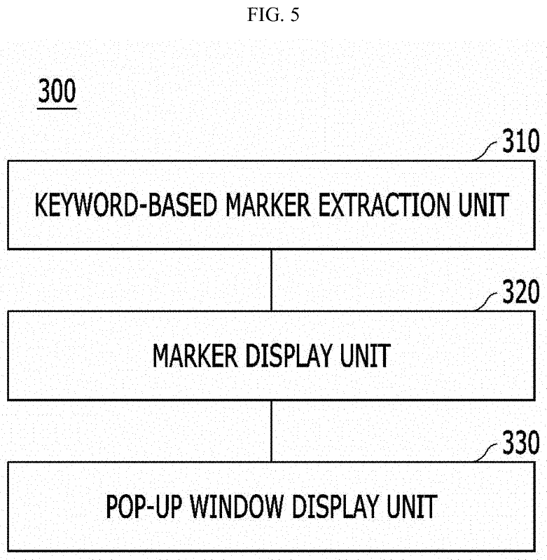

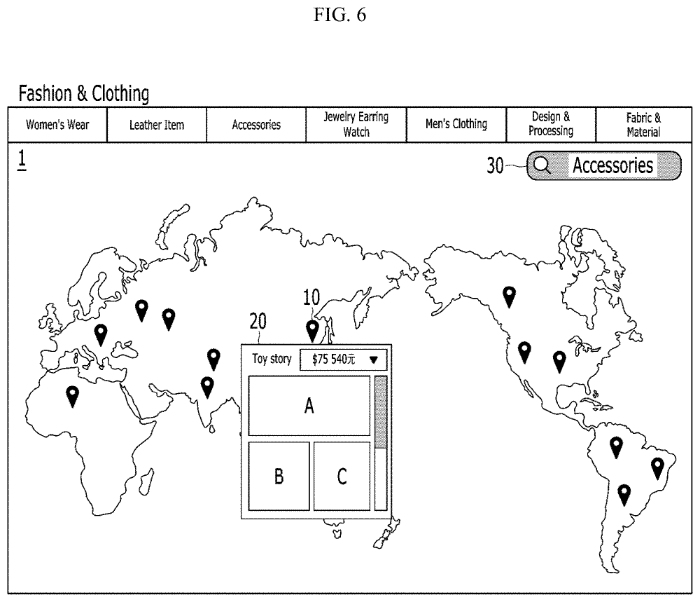

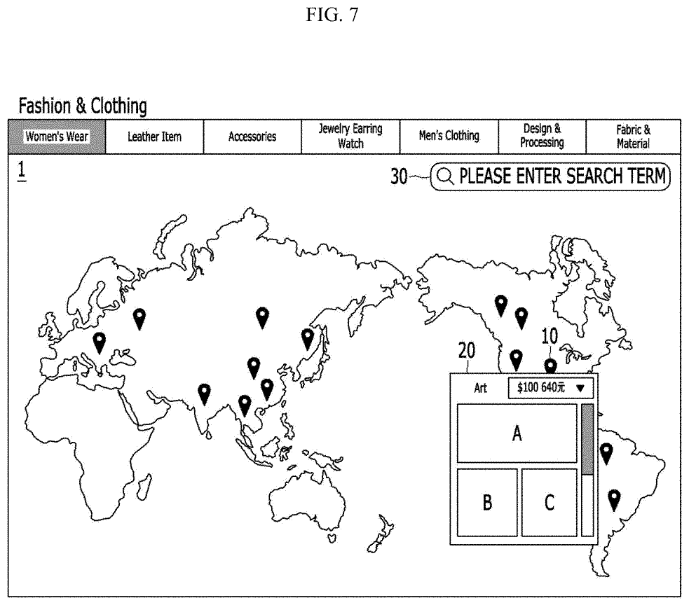

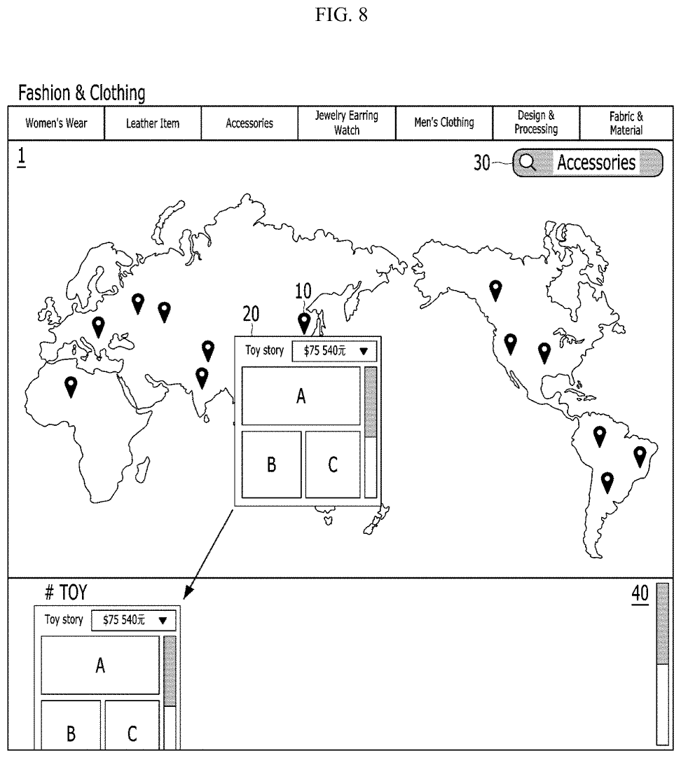

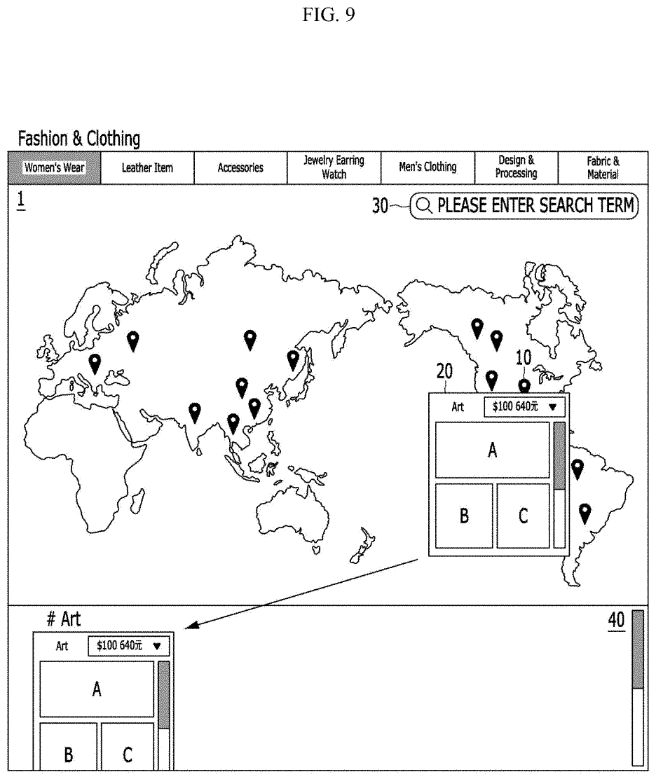

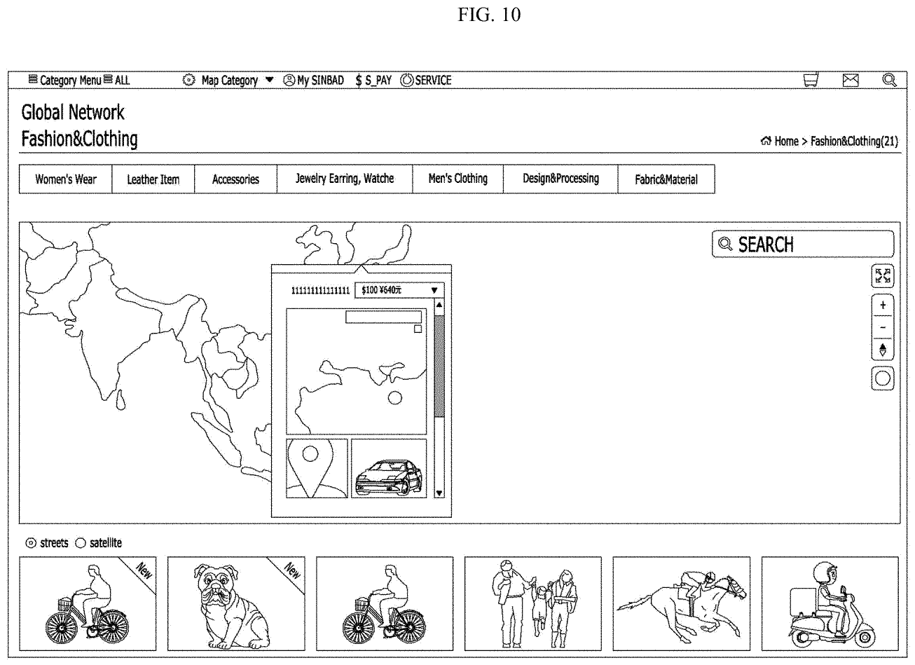

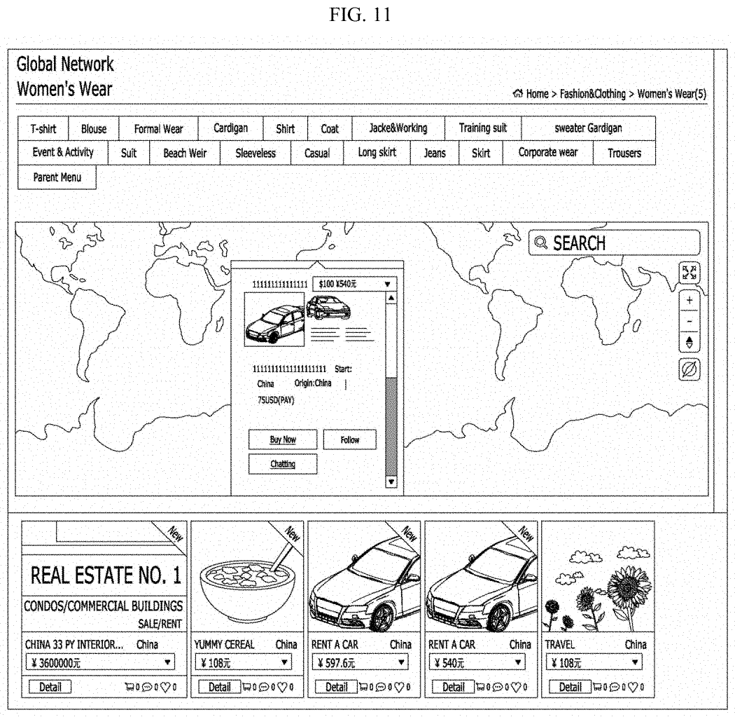

FIG. 1 is a schematic view for explaining the configuration relationship of an online shopping mall system through automated processing of content categories and maps according to an embodiment of the present invention. FIG. 2 is a block diagram for showing the overall configuration of an online shopping mall system through automated processing of content categories and maps according to an embodiment of the present invention. FIG. 3 is a block diagram for showing the configuration of a map marker generation unit according to an embodiment of the present invention. FIG. 4 is a view for illustrating the configuration of a main screen of an online shopping mall system through automated processing of content categories and maps according to an embodiment of the present invention. FIG. 5 is a block diagram for showing the configuration of a product information provision unit according to an embodiment of the present invention. FIGS. 6 and 7 are views for explaining functional configurations of a keyword-based marker extraction unit, a marker display unit, and a pop-up window display unit, respectively, according to an embodiment of the present invention. FIGS. 8, and 9 are views for explaining the functional configuration of a pop-up window list management unit according to an embodiment of the present invention.

Referring to FIG. 1, an online shopping mall system 1000 through automated processing of content categories and maps according to an embodiment of the present invention is implemented in the form of a web server that is connected to a user's communication terminal through an Internet communication network, and the web server may be implemented so that necessary information can be confirmed and transmitted to and received from the user's communication terminal through a specific website or dedicated application.

The web server may have the same hardware configuration as a conventional web server and may include program modules implemented through various types of languages such as C, C++, Java, Visual Basic, and Visual C to perform various functions in terms of software. Further, it can be implemented using a web server program that is provided in various ways according to operating systems such as DOS, Windows, Linux, Unix, and Macintosh in general server hardware.

Further, the web server is connected to each user's communication terminal through a network. An example of such a network is RF, 3rd generation partnership project (3GPP) network, long term evolution (LTE) network, 5th generation partnership project (5GPP) network, world Interoperability for microwave access (WiMAX) network, Internet, local area network (LAN), wireless local area network (wireless LAN), wide area network (WAN), personal area network (PAN), Bluetooth network, NFC network, satellite broadcasting network, an analog broadcasting network, digital multimedia broadcasting (DMB) network, etc. are included but are not limited thereto.

Referring to FIG. 2, the online shopping mall system 1000 through automated processing of content categories and maps, according to an embodiment of the present invention, comprises at least one map database unit 100, a map marker generation unit 200, a product information provision unit 300, a product payment processing unit 400, a store image information provision unit 500, and a pop-up window list management unit 600.

The map database unit 100 may store world map data and may output and provide more detailed map information according to requests from the product information provision unit 300 and the store image information provision unit 500. The map database unit 100 processes location information based on latitude and longitude information and each location information may be provided in correspondence with a marker 10 reflecting location information of an offline store, which is described later. However, stores in high-rise buildings that use the same latitude and longitude share the same latitude and longitude. Thus, when the map marker of such location is selected, all pop-up windows registered in that location are displayed to handle registrants using the same latitude and longitude.

The map marker generation unit may receive the registration of in which location information, product sales information, seller information, and sales product category information for an offline store, respectively, classify the product sales information into categories based on the sales product category information, and generate a plurality of markers 10 for providing the product sales information and the seller information on the map 1 provided through the map database unit 100 based on the location information;

To this end, the map marker generation unit 200 may comprise a sales information registration unit 210 and a marker generation unit 220 as shown in FIG. 3.

The sales information registration unit 210 receives location information, product sales information, seller information, and sales product category information of an offline store from a seller, respectively. The location information may include the offline store's latitude, longitude, and address. The sales information may include product name, product picture, product video (image, video, etc.), product price, etc. The seller information may include the seller's personal information (seller name, company name, and contact information) and account payment information. The sales product category information may include detailed information from the upper to lower categories (e.g., ‘fashion>women's clothing>blouse’). At this time, sales product category information may be input by selecting a menu button and automatically classified.

The marker generation unit 220 may automatically classify product sales information from upper category to lower category based on sales product category information, wherein the classification is performed to be searchable by search keyword. It may generate several markers as an interface for displaying product sales and seller information on the map 1 based on location information.

More specifically, when various information is completely registered through the sales information registration unit 210, the product is automatically determined to be classified into which category line using the sales product category information input through the user's menu selection among the registered information and registered product information may be extracted and provided according to the search request of the corresponding category.

Further, when various information is completely registered through the sales information registration unit 210, a marker 10 may be generated to output and provide the registered information on the map 1 using information such as latitude, longitude, and address among the registered information. At this time, each marker 10 is displayed according to the location information of the store on the map 1, as shown in FIG. 4, and when the corresponding marker 10 is selected (clicked or touched), the pre-registration information associated with the marker 10 may be output and provided on the map 1.

The product information provision unit 300, when a specific product category is an input as a search keyword, provides product sales information and seller information corresponding to the input product category on the map 1 through the marker 10. When a specific marker is selected among the plurality of markers, the product sales information and seller information corresponding to the selected marker 10 may be provided through the pop-up window 20 on the map 1.

To this end, the product information provision unit 300 may comprise a keyword-based marker extraction unit 310, a marker display unit 320, and a pop-up window display unit 330, as shown in FIG. 5.

The keyword-based marker extraction unit 310, when a search keyword is an input through the keyword search window 30 as shown in FIG. 6, may extract a marker 10 of a category matching the search keyword based on sales product category information.

For example, as shown in FIG. 6, when the keyword ‘Accessories’ is entered in the keyword search window 30, category keywords classified by matching with or related to the ‘Accessories’ keyword among pre-registered sales product category information are found to extract a marker 10 related to the found category.

The marker display unit 320 may display at least one marker extracted through the keyword-based marker extraction unit 310 on the map 1.

For example, if markers 10 related to ‘Accessories’ are extracted through the product information provision unit 300, markers other than the markers 10 related to ‘Accessories’ are not selectively displayed, thereby checking only the marker 10 for “Accessories’ on the map 1. Accordingly, it is possible to check information faster by removing unnecessary information other than the object the user wants to find.

Meanwhile, the keyword search window 30 of the keyword-based marker extraction unit 310 may be used when the user directly wants to find a product of a specific category. However, when the search keyword of the specific category is a parent keyword, for example, if it is an upper category such as ‘Fashion’ or ‘Clothing’ rather than ‘Accessories,’ each keyword for the lower categories related to the upper category such as ‘Women's Wear,’ ‘Leather Item,’ ‘Accessories,’ ‘Jewelry Earring, Watch,’ ‘Men's Clothing,’ ‘Design & Processing,’ ‘Fabric & Material,’ etc. may be provided as a selectable menu button as shown in FIG. 7. At this time, when the desired button is selected (clicked or touched) among the provided keyword menu buttons, information of the same result. As a result, using the keyword search window 30 described above may be provided.

The pop-up window display unit 330, when a specific marker is selected among the markers 10 displayed through the marker display unit 320, displays product sales information and seller information corresponding to the selected marker 10 through the pop-up window 20 on a map 1.

For example, when a marker 10 is displayed in a location in China as shown in FIG. 6 or a location in the U.S. as shown in FIG. 7, the surroundings of the selected marker 10 are selected (clicked or touched), a pop-up window 20 is displayed around the selected marker 10, and in the pop-up window 20, product sales information and seller information that allows users to purchase products in the category they have found, that is, information on product name, product photo, product video (image, video, etc.), product price, seller name, business name, contact information and account payment may be displayed. Further, through ‘Follow’ for an offline store or a specific product symbolized by the marker 10, product update information or news information for the corresponding store or specific product may be received as a notification.

Further, the pop-up window display unit 330 may display at least one of the enlarged maps and a road view of the surrounding area centered on the offline store corresponding to the marker 10 selected by the user.

For example, when the map is moved to the vicinity of Dongdaemun in Seoul, Korea, and then a marker (10) in the Dongdaemun area is selected, an enlarged map around the building of the store corresponding to the marker 10 is displayed in a portion of the corresponding pop-up window 20, and the corresponding map area may be enlarged or reduced, or a road view of the corresponding area may be displayed through a road view button.

The product payment processing unit 400 may process payment according to a product purchase request through the pop-up window 20. This product payment processing unit 400 may support payment processing through various payment methods such as credit card, cash, electronic money, and electrical payment and enable organic processing of the corresponding work so that delivery may be made in cooperation with the delivery company later.

The store image information provision unit 500 receives the registration of the image information of the exterior image of the building and the indoor stereoscopic space of the offline store, respectively. When the marker 10 corresponding to each offline store is selected, the image of the exterior of the building and the indoor stereoscopic space of the offline store may be provided. As described above, similarly to the pop-up window display unit 330 providing a road view, the store image information provision unit 500 may show the surrounding environment of the corresponding store. However, the difference is that the store image information provision unit 500 may show the store's inside and exterior view or the road view. The interior of such an offline store may be a decisive factor in purchasing a product from the point of view of a user who purchases a product from the corresponding store. That is, an indoor 3D view or 3D graphics of the corresponding store are provided to act as an important factor for some users when deciding to purchase as a scale for estimating the scale of the corresponding store.

The pop-up window list management unit 600, when the pop-up window 20 displayed on the map 1 is moved to the pop-up list area 40 outside the map 1 of the web page through a drag-and-drop method, adds the pop-up windows 20 dropped to the corresponding area in the form of a list, classifies and sorts by the dropped time, product category, and product price, and then displays them for use. The pop-up window 20 may be deleted according to the user's selection.

For example, as shown in FIGS. 8 and 9, when the pop-up window 20 is desired to be deactivated for a while to search for another category or other product while checking the pop-up window 20 for a product of the category ‘TOY,’ the pop-up window 20 displayed on the map 1 is dragged and dropped on the pop-up list area 40 provided at the bottom of the screen so that the dropped pop-up window 20 may be selectively displayed in a preview format (same as a thumbnail image). Although the pop-up windows 20 of several categories are checked and then dragged and dropped to the pop-up list area 30, the product categories included in the pop-up window 20 are recognized to classify and sort the pop-up windows 20 by each category in the pop-up list area 40. When the sorted pop-up window 20 is selected (clicked or touched) within the pop-up list area 40, it may be floated and activated around the corresponding marker 10 on the map 1.

The above description is only one embodiment for implementing an online shopping mall system through automated processing of content categories and maps according to the present invention, and the present invention is not limited to the above embodiment. As claimed in the following claims, the technical spirit of the present invention includes the scope in which various changes can be made by anyone skilled in the art without departing from the gist of the present invention.

1. An online shopping mall system through automated processing of content categories and maps, the online shopping mall system comprising:
a map database unit storing map data for at least one country;
a map marker generation unit receiving the registration of in which location information, product sales information, seller information, and sales product category information for an offline store, respectively, classifying the product sales information into categories based on the sales product category information, and generating a plurality of markers for providing the product sales information and the seller information on a map provided through the map database unit based on the location information;
a product information provision unit providing, when a specific product category is input as a search keyword, product sales information and seller information corresponding to the input product category through the marker on the map, and providing, when a specific marker is selected from among the plurality of markers, product sales information and seller information corresponding to the selected marker through a pop-up window on the map; and
a product payment processing unit processing payment according to a product purchase request through the pop-up window.

2. The system of claim 1, wherein the map marker generation unit comprises:
a sales information registration unit receiving location information including the latitude and longitude of the offline store, product sales information including product name, product picture, product video and product price, seller information including seller personal information and account payment information, and sales product category information, respectively, from the seller; and
a marker generation unit automatically classifying the product sales information from a higher category to a lower category based on the sales product category information wherein the product sales information is classified so as to be searchable by the search keyword and generating the plurality of markers as an interface for outputting product sales information and seller information on a map based on the location information.

3. The system of claim 1, wherein the product information provision unit comprises:
a keyword-based marker extraction unit extracting, when a search keyword is input through the keyword search window, a marker of a category matching the corresponding search keyword based on the sales product category information;
a marker display unit displaying at least one marker extracted through the keyword-based marker extraction unit on the map; and
a pop-up window display unit displaying, when a specific marker is selected among the markers displayed through the marker display unit, product sales information and seller information corresponding to the selected marker through a pop-up window on the map.

4. The system of claim 3, wherein the pop-up window display unit further displays at least one of an enlarged map and a road view of a surrounding area centered on an offline store corresponding to a marker selected by a user.

5. The system of claim 1, further comprising a store image information provision unit receiving the external image of the building and the indoor stereoscopic space image information, respectively, of the offline store and providing, when a marker corresponding to each offline store is selected, the external image of the building and the indoor stereoscopic space image of the corresponding offline store.
